(19) United States
(12) Patent Application Publication
(10) Pub. No.: US 2002/0081484 A1
(43) Pub. Date: Jun. 27, 2002

(54) Safety vent for extended battery storage

(75) Inventor: Ivan Exnar, Itingen (CH)

Correspondence Address: SUGHRUE, MION, ZINN,, MACPEAK & SEAS,PLLC, 2100 Pennsylvania Avenue, N.W., Washington, DC, 20037-3202, US

(73) Assignee: RENATA A.G.

(21) Appl. No.: 10/000,962

(22) Filed: Dec. 4, 2001

(30) Foreign Application Priority Data
Dec. 21, 2000 (EP) 00204723.1

(51) Int. Cl. H01M 2/12

(52) U.S. Cl. 429/56; 429/82

(57) ABSTRACT

The battery includes a metal container containing active materials, forming respectively the anode and the cathode, and an electrolyte, said container being sealed at its upper part by a hermetically sealed cap and separated from the active materials by an insulating element, said cap being provided with two contact terminals, electrically connected to the anode and the cathode by connecting means, and a through passage formed by a tube arranged in proximity to or merged with the negative terminal, said through passage, connecting the interior and the exterior of the battery, being closed to wards the exterior by a metal hotmelt composition. The event is characterized in that said through passage is further closed to wards the interior by an organic composition which is inert as regards the electrolyte and has a melting point lower than or equal to that of the metal hotmelt composition

The present invention concerns a safety vent for a battery or accumulator, designated hereinafter by the generic term “battery ”, which allows storage time before use to be increased without any risk of said vent deteriorating. The invention concerns in particular a lithium-ion type battery wherein the safety vent is formed by a hotmelt composition sensitive to any abnormal rise in temperature.

During the last decades, batteries of the lithium-ion type, whether they are rod, button or prism-shaped, have seen significant development, since they have the advantage of having high energy density, a particularly useful quality for portable electronic apparatus, such as mobile telephones, portable computers, or video cameras.

However, in counterpoint to this quality, such batteries carry risks if certain conditions of use are not respected or if said batteries are not fitted with devices able, in particular, to keep the voltage and temperature within a “safety window”. Indeed, when the battery is in a closed circuit with a high current demand, during the charging phase for an accumulator, or when there is a malfunction or incorrect use, the chemical reactions which are generated can cause partial decomposition of the electrolyte leading to an increase in internal pressure and a rise in temperature which may goes as far as an explosion, or inflammation of said battery.

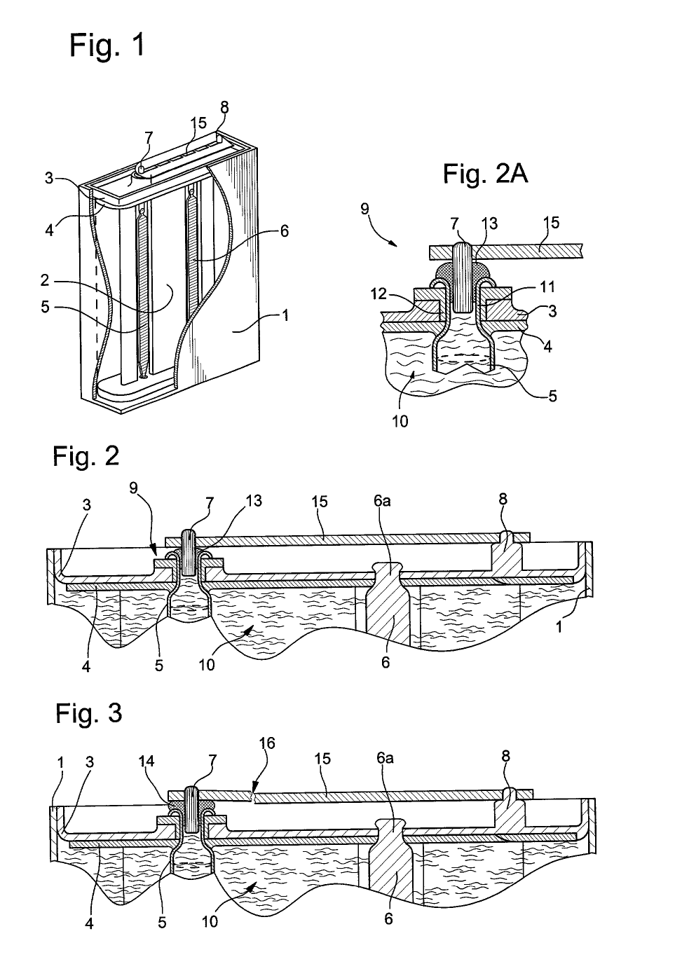

As regards voltage, the window of safety is located between 3 and 4.2 volts. The most common device for keeping the voltage within this window, or more exactly for switching off the battery if the voltage is outside the window, consists of welding an electronic circuit between the terminals, as shown in FIG. 1.

As regards the temperature, the safety window corresponds to a critical temperature of less than 160° C. for lithium-ion type batteries. In order to keep the temperature lower than a critical value numerous devices have been proposed to dissipate heat, for example by facilitating the flow of cooling fluids, as indicated for example in European Patent Application Nos. 0 596 778 and 0 613 204, or by providing ribs like a radiator, as indicated for example in European Patent Application No. 0 403 569. In the event that the heat dissipation devices prove insufficient, it is also possible to provide a safety vent allowing the interior of the battery to communicate with the external environment. Such a vent is formed by an orifice or a conduit which connects the interior and exterior of the battery and which is closed by a plug of hotmelt composition having a melting point lower than the critical temperature. The hotmelt composition is preferably formed by a composition of metals selected from among tin, bismuth, lead, cadmium, silver, gallium and indium and whose melting point is comprised between 90° C. and 150° C. These plugs of hotmelt composition may be arranged at any place on the battery container, for example through the cover. In the embodiments described in European Patent Application 0 948 065, the hotmelt composition is arranged in a gap formed between a tube passing through the cover and a rod forming a terminal as shown in FIG. 1 and in enlarged cross-section in FIG. 2.

In any case, according to the aforecited prior art, the hotmelt composition is always in contact with the electrolyte, including during storage. The safety vent thus cannot be prompted by the operation or malfunction of the battery. Conversely, at the location of the negative electrode, the electrolyte can react with the metals present in the hotmelt composition. This is the case in particular when the electrolyte contains very reactive lithium ion for example triflate or lithium hexafluorophosphate, and when the hotmelt composition contains tin for example. It then forms an intermetallic compound LiSnx the specific volume of which may reach up to 300% of the initial volume, as is clear from the publication by M. Winter et al. (“Insertion electrode materials for rechargeable lithium batteries”, Adv. Mater. 1998, 10, No 10).

Even if this phenomenon does not lead to expulsion of the hotmelt plug, this has the major drawback of compromising the sealing of the battery and may also cause modification in the dimensions of the battery preventing the insertion thereof in a housing provided to the initial dimensions, or breaking an electronic circuit inserted between the terminals. FIG. 2 shows schematically the state of a vent of this prior art at the beginning of storage and FIG. 3 after a certain storage period.

The object of the present invention is to overcome the aforementioned drawbacks by providing a battery able to have a longer storage period prior to use than that of batteries of the prior art, without any risk of damaging the vent.

The invention thus concerns a safety vent arranged at the negative pole of a battery having a metal container containing active materials, respectively forming the anode and the cathode, impregnated with an electrolyte. The container is sealed at its top part by a hermetically sealed cap and separated from the active materials by an insulating element. The cap is provided with two contact terminals electrically connected to the anode and the cathode by connecting means and a through passage, connecting the interior and the exterior of the battery, closed towards the exterior by a metallic hotmelt composition. The vent according to the invention is characterised in that said through passage is closed towards the inside by an organic composition which is inert as regards the electrolyte and which has a melting point lower than or equal to the metallic hotmelt composition.

The through passage is preferably formed by a sleeve or a tube allowing the cap and the insulating element to be blocked together.

The safety vent may be made in accordance with one of the embodiments disclosed in European Patent No. 0 948 065 as will be explained in more detail in the following examples.

Other features and advantages of the present invention will appear in the following description of a prismatic battery, taken by way of non limiting example, with reference to the annexed drawings, in which:

FIG. 1 is a partially torn away perspective diagram of a battery according to the prior art;

FIG. 2 is a cross-section along the large plane of symmetry of the upper part of the battery shown in FIG. 1, at the beginning of storage;

FIG. 2A is an enlarged diagram of the vent of FIG. 2;

FIG. 3 corresponds to FIG. 2 and shows the deterioration caused by extended storage; and

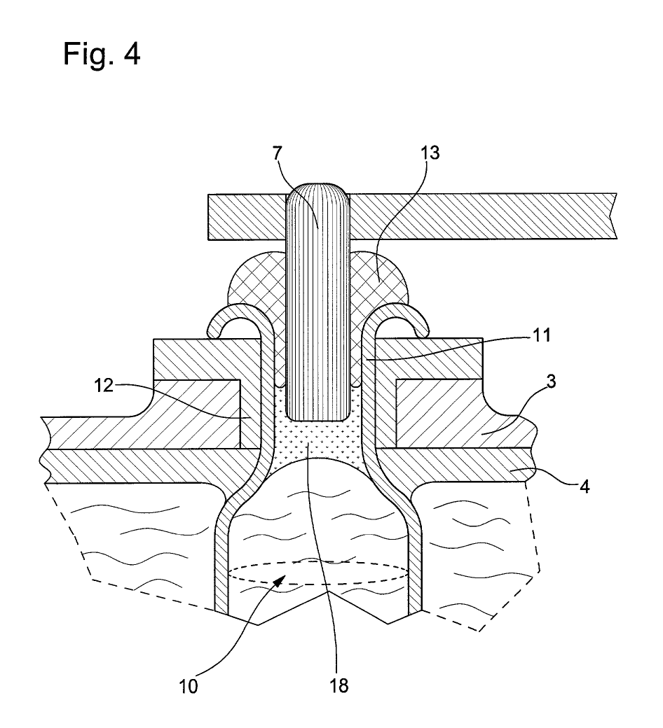

FIG. 4 shows along the same cross-section as that of FIGS. 2 and 3 an embodiment of a safety vent according to the invention.

In the following description a safety vent according to the invention is fitted to a prismatic lithium-ion battery with a wound coil, of the type described in European Patent Application No. 0 948 072 in the name of the Applicant and incorporated in the present Application by reference.

A battery, according to European Patent Application No. 0 948 072 shown in partially torn away perspective in FIG. 1, includes a metal container 1, intended to be hermetically sealed by a cap 3, welded onto its periphery. Container 1 contains a coil 2 made of an insulating material, formed by a lower plate and an upper plate forming an insulating element 4. A neck joins the two plates and includes, close to its edges, recesses in which are placed connecting means 5, 6 electrically connected to contact terminals 7, 8. These connecting means 5, 6 are the anchoring points of a composite strip (not shown) containing the materials of the anode and the cathode, wound onto coil 2. This winding is impregnated with an electrolyte 10 occupying the entire cavity of container 2, as shown in the cross-section of FIG. 2, made along a median plane parallel to a large surface of the battery. In this example the electrolyte used contains a lithium salt, such as triflate or lithium hexafluorophosphate. In this embodiment, connecting means 6 is welded at 6a in the cap which forms the electric junction with positive terminal 8 which is offset close to the end of cap 3 to allow an electronic circuit 15, connected to negative terminal 7, to be set in place. Terminal 7 is fitted with a safety vent 9, shown in larger scale in FIG. 2A, of the type of those described in the aforecited European Patent No. 0 948 965. This vent 9 basically includes a tube 11, the extension of which into the interior of container I is flattened to form connecting means 5, said tube allowing insulating element 4 and cover 3 to be clamped while being electrically insulated therefrom by means of an insulating sleeve 12 with a flange. Tube 11 is closed towards the exterior by a metal hotmelt material 13 through which a small portion of rod forming negative terminal 7 passes, said composition 13 being in contact with electrolyte 10. in this example, a tin, bismuth and lead alloy (35.7/35.7/28.6) with a melting point of 102° C. has been used, available from Alpha-Fry Technologies Nuremberg (Germany).

In a “normal” beginning of storage situation shown in FIG. 2, metal hotmelt composition 13 perfectly closes the vent and it can be seen that protective electronic circuit 15 is substantially parallel to the cap.

After a certain storage time, the lithium ions have reacted with the tin to form an intermetallic compound LiSnₓ able to increase the specific volume of the hotmelt composition by up to 300%. This increase in volume is accompanied by a mechanical embrittlement of the vent able to cause a reduction in sealing and produce, as shown in FIG. 3, an expansion 14 towards the exterior, driving contact rod 7, which may cause a breakage 16 in electronic circuit 15. Expansion 14 may continue to close the vent more or less effectively, but extend beyond the end of the contacts, and thereby make an operational battery useless because it can no longer be inserted in the housing provided for that purpose in a portable electronic apparatus.

With reference now to FIG. 4, a safety vent 9 according to the invention is shown, able to be adapted to any type of battery in which there is a risk of a side reaction between electrolyte 10 and a hotmelt compound 13 of the vent. This is for example the case, as indicated previously, when the electrolyte contains lithium ions and when the hotmelt composition is for example tin-based. This vent, formed in proximity to or merged with negative terminal 7, has the same general structure as that which was described with reference to FIG. 2A. It differs therefrom fundamentally however in that the inner opening of sleeve 11 is sealed by an organic composition 18, which is inert as regards electrolyte 10 and has a melting point lower than or equal to that of metal hotmelt composition 13. This organic composition is for example a paraffin type wax, available in particular under the reference Microwax HW9822 from Paramelt Heerhugowaardn (Netherlands). In a storage period under normal temperature conditions organic composition 18 will prevent any side reaction between electrolyte 10 and metal hotmelt composition 13. When the battery is in service and, for some reason, its inner temperature goes above the safety window, the organic composition, then its metal composition will melt and free the passage of the vent.

Other embodiments may be envisaged by those skilled in the art without departing from the scope of the present invention.

What is claimed is:

1. A safety vent for a battery having a metal container containing active materials, forming respectively the anode and the cathode, and an electrolyte, said container being sealed at its upper part by a hermetically sealed cap and separated from the active materials by an insulating element, said cap being provided with two contact terminals, electrically connected to the anode and the cathode by connecting means, and a through passage formed by a tube arranged in proximity to or merged with the negative terminal, said through passage, connecting the interior and the exterior of the battery, being closed to wards the exterior by a metal thermally fusible composition, wherein said through passage is further closed to wards the interior by an organic composition which is inert as regards the electrolyte and has a melting point lower than or equal to that of the metal hotmelt composition.

2. A safety vent according to claim 1, wherein the through passage is formed by a tube crimped on the outside by bending its edges over the cap, having a larger diameter inside, forming a shoulder abutting against the insulating element and extending inside the container to form connecting means.

3. A safety vent according to claim 1, wherein a rod forming a battery terminal passes through the metal hotmelt composition.

4. Safety vent according to claim 3, wherein the end of the rod forming a terminal is connected to the other terminal by an electronic circuit.

5. A safety vent according to claim 1, wherein the electrolyte is a lithium salt and in that the metal hotmelt composition contains tin and at least one other metal selected from among bismuth, lead, cadmium, silver, gallium and indium.

6. A safety vent according to claim 6, wherein the metal hotmelt composition has a melting point of less than 160° C.

7. A safety vent according to claim 1, wherein the organic composition is a paraffin type wax.
